(19) United States
(12) Patent Application Publication
(10) Pub. No.: US 2025/0317281 A1
(43) Pub. Date: Oct. 9, 2025

(54) SYSTEM FOR IMPLEMENTING QUANTUM KEY DISTRIBUTION (QKD) IN A DATA CENTER ENVIRONMENT

(71) Applicant: MELLANOX TECHNOLOGIES, LTD., Yokneam (IL)

(72) Inventors: Ziv ABELSON, Even Yehuda (IL); Elad MENTOVICH, Tel Aviv (IL); Isabelle CESTIER, Haifa (IL); Tal GOFMAN, Haifa (IL); Ran HASSON RUSO, Pardes Hanna-Karkur (IL)

(73) Assignee: MELLANOX TECHNOLOGIES, LTD., Yokneam (IL)

(21) Appl. No.: 18/630,704

(22) Filed: Apr. 9, 2024

(51) Int. Cl. H04L 9/08

(52) U.S. Cl. CPC H04L 9/0852; H04L 9/0819; H04L 9/085

(57) ABSTRACT

Systems and methods are described for implementing quantum key distribution (QKD) in a data center environment. An example quantum transmitter includes an on-chip semiconductor laser as a light source to generate photons, quantum state preparation circuitry configured to receive a sequence of bits, map each bit to a quantum state and a measurement basis, and encode the quantum state of each bit onto a corresponding photon to generate a qubit, and a quantum channel interface configured to transmit the qubit to a quantum receiver via a quantum communication channel. An example quantum receiver includes a quantum channel interface to receive qubits, a silicon-based single photon avalanche diode (SPAD) as a photon detector for qubit detection, and quantum state measurement circuitry that is configured to decode the state of each qubit based on a selected measurement basis.

### TECHNOLOGICAL FIELD

Example embodiments of the present invention relate to implementing quantum key distribution (QKD) in a data center environment.

### BACKGROUND

Quantum Key Distribution (QKD) is a secure communication method that utilizes the principles of quantum mechanics to generate and share a cryptographic key between two parties in a manner that is inherently secure against eavesdropping. Implementing QKD within a data center environment presents both technological and financial challenges that make it currently impractical.

Applicant has identified a number of deficiencies and problems associated with implementing QKD in a data center environment. Many of these identified problems have been solved by developing solutions that are included in embodiments of the present disclosure, many examples of which are described in detail herein.

### BRIEF SUMMARY

Systems and methods are therefore provided for implementing quantum key distribution (QKD) in a data center environment.

In one aspect, a quantum transmitter for use in quantum key distribution (QKD) is presented. The quantum transmitter comprising: a light source configured to generate photons, wherein the light source is an on-chip semiconductor laser; quantum state preparation circuitry operatively coupled to the light source and configured to: receive a sequence of bits; map each bit to a quantum state and a measurement basis; and encode the quantum state of each bit onto a corresponding photon based on the measurement basis to generate a corresponding qubit; and a quantum channel interface operatively coupled to the quantum state preparation circuitry and configured to transmit the corresponding qubit to a quantum receiver via a quantum communication channel.

In some embodiments, the light source is further configured to generate the photons at an infra-red frequency, a near infra-red frequency, or a visible spectrum frequency.

In some embodiments, the light source is further configured to generate the photons at an operational wavelength of around 850 nm.

In some embodiments, the quantum transmitter has a small form factor that is less than 40 cm3 in volume.

In some embodiments, the quantum transmitter is configured to operate at a room temperature.

In some embodiments, the security and protocol management circuitry configured to: transmit, via a classical communication channel, the measurement basis used to encode each bit to the quantum receiver.

In some embodiments, the security and protocol management circuitry is further configured to: receive, from the quantum receiver via the classical communication channel, a measurement basis for decoding each qubit; and establish a shared encryption key with the quantum receiver using bits and corresponding qubits having matching measurement bases.

In some embodiments, a transmission distance between the quantum transmitter and the quantum receiver is less than 2 km.

In some embodiments, the quantum state preparation circuitry is configured to receive the sequence of bits from a random number generator.

In another aspect, a quantum receiver for use in quantum key distribution (QKD) is presented. The quantum receiver comprising: a quantum channel interface configured to receive, via a quantum communication channel, qubits from a quantum transmitter; a photon detector operatively coupled to the quantum channel interface and configured to detect the qubits, wherein the photon detector is a silicon-based single photon avalanche diode (SPAD); and quantum state measurement circuitry operatively coupled to the photon detector and configured to: select a measurement basis to decode a state of each qubit; and decode the state of each qubit based on the measurement basis.

In some embodiments, the photon detector is further configured to detect the qubits at an infra-red frequency, a near infra-red frequency, or a visible spectrum frequency.

In some embodiments, the photon detector is further configured to detect the qubits at an operational wavelength of around 850 nm.

In some embodiments, the quantum receiver has a small form factor that is less than 40 cm3 in volume.

In some embodiments, the quantum receiver is configured to operate at a room temperature.

In some embodiments, comprising security and protocol management circuitry configured to: transmit, via a classical communication channel, the measurement basis used to decode each qubit to the quantum transmitter.

In some embodiments, the security and protocol management circuitry is further configured to: receive, from the quantum transmitter via the classical communication channel, a measurement basis used to encode each bit; and establish a shared encryption key with the quantum transmitter using bits and corresponding qubits with matching measurement bases.

In yet another aspect, a method for data transmission using quantum transmitter in quantum key distribution (QKD) is presented. The method comprising: generating, using a light source, photons, wherein the light source is an on-chip semiconductor laser; receiving a sequence of bits; mapping, using a quantum state preparation circuitry, each bit to a quantum state and a measurement basis; encoding, using the quantum state preparation circuitry, the quantum state of each bit onto a corresponding photon based on the measurement basis to generate a corresponding qubit; and transmitting, using a quantum channel interface, the corresponding qubit to a quantum receiver via a quantum communication channel.

In yet another aspect, a method for data reception using quantum receiver in quantum key distribution (QKD) is presented. The method comprising: receiving, using a quantum channel interface, qubits from a quantum transmitter; detecting, using a photon detector, qubits, wherein the photon detector is a silicon-based single photon avalanche diode (SPAD); selecting, using a quantum state measurement circuitry, a measurement basis to decode a state of each qubit; and decoding, using the quantum state measurement circuitry, a state of each qubit based on the measurement basis.

In yet another aspect, a quantum transmitter for use in quantum key distribution (QKD) is presented. The quantum transmitter comprising: a light source configured to generate photons, wherein the light source is configured to generate the photons at an operational wavelength of around 850 nm; quantum state preparation circuitry operatively coupled to the light source and configured to: receive a sequence of bits; map each bit to a quantum state and a measurement basis; and encode the quantum state of each bit onto a corresponding photon based on the measurement basis to generate a corresponding qubit; and a quantum channel interface operatively coupled to the quantum state preparation circuitry and configured to transmit the corresponding qubit to a quantum receiver via a quantum communication channel.

In yet another aspect, a quantum receiver for use in quantum key distribution (QKD) is presented. The quantum receiver comprising: a quantum channel interface configured to receive, via a quantum communication channel, qubits from a quantum transmitter; a photon detector operatively coupled to the quantum channel interface and configured to detect the qubits, wherein the photon detector is configured to detect the qubits at an operational wavelength of around 850 nm; and quantum state measurement circuitry operatively coupled to the photon detector and configured to: select a measurement basis to decode a state of each qubit; and decode the state of each qubit based on the measurement basis.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having described certain example embodiments of the present disclosure in general terms above, reference will now be made to the accompanying drawings. The components illustrated in the figures may or may not be present in certain embodiments described herein. Some embodiments may include fewer (or more) components than those shown in the figures.

FIGS. 1A-1C illustrate an example system environment for implementing quantum key distribution (QKD) in a data center environment, in accordance with an embodiment of the present invention;

FIG. 2 illustrates an example method for data transmission using a quantum transmitter, in accordance with an embodiment of the invention; and

FIG. 3 illustrates an example method for data reception using the quantum transmitter, in accordance with an embodiment of the present invention.

### DETAILED DESCRIPTION

### Overview

Quantum Key Distribution (QKD) is a secure communication method that utilizes the principles of quantum mechanics to generate and share a cryptographic key between two parties in a manner that is inherently secure against eavesdropping. There are two primary types of QKD: Discrete Variable Quantum Key Distribution (DV-QKD) and Continuous Variable Quantum Key Distribution (CV-QKD). Each type utilizes distinct aspects of quantum mechanics to achieve secure communication. DV-QKD relies on the quantum properties of individual particles, such as photons, to encode information. This method typically utilizes the polarization or phase of single photons to represent the binary values 0 and 1. CV-QKD, in contrast, encodes information in the continuous quantum variables of light, such as the amplitude-phase, or quadratures of coherent states of light. This approach does not rely on single photons but rather on the quantum fluctuations of light fields, which can be measured using homodyne or heterodyne detection techniques.

Data center environments store, process, and distribute vast amounts of data, requiring robust security protocols to safeguard against unauthorized access and potential data breaches. The integration of QKD into data center security architectures offers a promising solution to these challenges. However, implement QKD within a data center environment presents both technological and financial challenges that make it currently impractical. Unlike traditional QKD applications that typically involve a single, secure point-to-point connection over long distances, a data center environment necessitates a complex network of multiple QKD links to securely connect various servers and devices within the facility. This requirement for numerous point-to-point connections deviates from the conventional QKD model, introducing complexity in setup and management. Unlike operational ranges of conventional implementations of QKD systems, the operational range required for a QKD system within a data center is comparatively short, in the range of 2 km.

Conventional QKD systems operate at 1550 nm and are optimized for long-distance transmission in telecommunications infrastructures. To implement QKD in a data center environment, embodiments of the invention contemplate a shift the operational wavelength of the QKD system from the traditional 1550 nm to 850 nm. DV-QKD is inherently suited to the shift in the operational wavelength. Operating at 850 nm enables the use of on-chip semiconductor lasers, such as Vertical-Cavity Surface-Emitting Lasers (VCSELs) as the light source and silicon- based single photon avalanche diodes (SPADs) as the photon detector. On-chip semiconductor lasers are particularly suitable for this application due to their small size, lower cost, and the ability to be fabricated using standard semiconductor processing techniques. Similarly, silicon-based SPADs are cost effective and more readily integrated into existing semiconductor manufacturing processes as compared to photodiodes used for longer wavelengths. Furthermore, at 850 nm, quantum devices, such as quantum receivers, experience lower levels of thermal noise and are more efficient at room temperature, obviating the need for elaborate cooling systems. This reduction in cooling requirements allows for a more compact and energy-efficient design, facilitating a denser implementation of the DV-QKD system within the data center environment, further contributing to the scalability and practicality of deploying quantum encryption technology in these settings. Additionally, the shift to an 850 nm operational wavelength enables the realization of small form factor (e.g., less than 40 cm³ in volume) for DV-QKD devices (e.g., the quantum transmitter and the quantum receiver). Conversely, CV-QKD systems, which encode information in the continuous properties of light, such as amplitude-phase, or quadratures, may face challenges at the 850 nm wavelength due to detector technology constraints, system complexity, and associated cost. However, CV-QKD can nevertheless be adapted for use within data center settings at the 1550 nm wavelength.

Embodiments of the present disclosure will now be described more fully hereinafter with reference to the accompanying drawings, in which some, but not all, embodiments of the present disclosure are shown. Indeed, the present disclosure may be embodied in many different forms and should not be construed as limited to the embodiments set forth herein; rather, these embodiments are provided so that this disclosure will satisfy applicable legal requirements. Thus, it should be understood that each block of the block diagrams and flowchart illustrations may be implemented in the form of a computer program product; an entirely hardware embodiment; an entirely firmware embodiment; a combination of hardware, computer program products, and/or firmware; and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments may produce specifically-configured machines performing the steps or operations specified in the block diagrams and flowchart illustrations. Accordingly, the block diagrams and flowchart illustrations support various combinations of embodiments for performing the specified instructions, operations, or steps.

Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, “operatively coupled” may mean that the components are electronically or optically coupled and/or are in electrical or optical communication with one another. Furthermore, “operatively coupled” may mean that the components may be formed integrally with each other or may be formed separately and coupled together. Furthermore, “operatively coupled” may mean that the components may be directly connected to each other or may be connected to each other with one or more components (e.g., connectors) located between the components that are operatively coupled together. Furthermore, “operatively coupled” may mean that the components are detachable from each other or that they are permanently coupled together.

As used herein, ‘QKD’ or ‘quantum key distribution’ systems may refer to technologies and methodologies employed in the secure generation and distribution of cryptographic keys utilizing the principles of quantum mechanics. Notwithstanding the broad application of the term ‘QKD,’ it is expressly understood that, unless otherwise specified, references herein predominantly pertain to DV-QKD systems. DV-QKD systems are characterized by their use of discrete quantum states, such as photon polarization, for the purpose of encoding and transmitting cryptographic information. This specification should not be construed to exclude the applicability or potential utility of CV-QKD systems, which utilize continuous quantum variables for encryption key distribution. The inclusivity of both DV-QKD and CV-QKD within the scope of ‘QKD’ as discussed herein allows for a comprehensive consideration of quantum key distribution technologies within data center environments, while acknowledging a primary focus on the implementations and considerations relevant to DV-QKD systems.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, satisfied, etc.

It should be understood that the word “exemplary” is used herein to mean “serving as an example, instance, or illustration.” Any implementation described herein as “exemplary” is not necessarily to be construed as advantageous over other implementations.

Furthermore, as would be evident to one of ordinary skill in the art in light of the present disclosure, the terms “substantially” and “approximately” indicate that the referenced element or associated description is accurate to within applicable engineering tolerances.

### Example System Environment

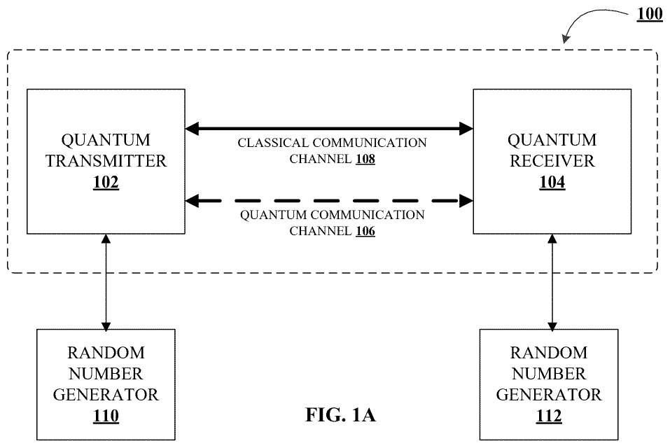

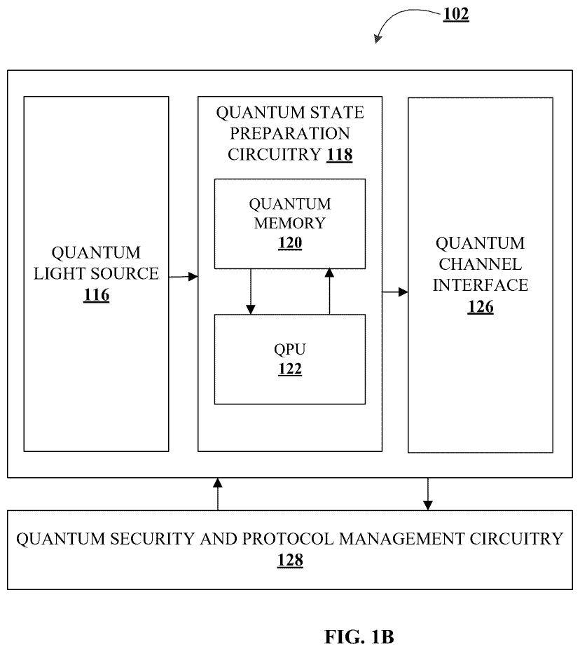

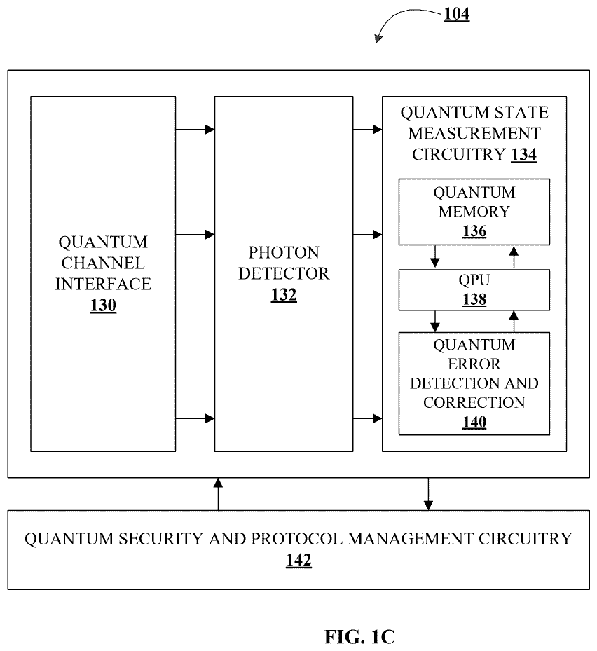

FIGS. 1A-1C illustrate an example system environment 100 for implementing QKD in a data center environment, in accordance with an embodiment of the present invention. As shown in FIG. 1A, the system environment 100 may include a quantum transmitter 102, a quantum receiver 104, a quantum communication channel 106 operatively coupling the quantum transmitter 102 and the quantum receiver 104, a classical communication channel operatively coupling the quantum transmitter 102 and the quantum receiver 104, a random number generator 110 operatively coupled to the quantum transmitter 102, and a random number generator 112 operatively coupled to the quantum receiver 104. FIG. 1A illustrates only one example of an embodiment of the system environment 100, and it will be appreciated that in other embodiments one or more of the systems, units, devices, and/or servers (e.g., quantum transmitter 102) may be combined into a single system, unit, device, or server, or be made up of multiple systems, devices, or servers. Also, the system environment 100 may include multiple units, same or similar to quantum transmitter 102 or quantum receiver 104, with each unit providing portions of the necessary operations.

According to embodiments of the invention, quantum components of the system environment 100, such as the quantum transmitter 102 and the quantum receiver 104, may be configured to operate at an infra-red frequency, a near infra-red frequency, or a visible spectrum frequency. In particular, the quantum components may be configured to operate at an operational wavelength of 850 nm. With an operational wavelength of 850 nm instead of 1550 nm the quantum transmitter 102 may operate with relatively lower energy requirements for generating and manipulating photons. Similarly, an operational wavelength of 850 nm may allow the quantum receiver 104 to operate with lower energy requirements for detecting and measuring photons. Moreover, the ability to operate at wavelengths of 850 nm allows the quantum components to function effectively at ambient temperature conditions and have a small form factor construction (e.g., less than 40 cm³ in volume). In addition, photons within this wavelength range can be produced and controlled without the significant thermal noise that higher energy photons would introduce. As a result, specialized cooling systems that are typically required for conventional quantum components operating at 1550 nm wavelengths, where thermal noise becomes a more pronounced issue, are no longer required according to embodiments of the present invention. The absence of such cooling systems not only contributes to a reduction in the overall size and complexity of the quantum components but also enhances their practicality for a broader range of applications within QKD systems. This operational flexibility at room temperature, combined with a smaller physical footprint, allows for deployment of quantum components in a data center environment. Moreover, the close proximity of the communicating parties within the data center environment means that the quantum communication channel—through which the qubits are transmitted—experiences minimal loss. This enables a favorable balance between achieving high key generation rates (speed at which secure keys are generated) and maintaining low power consumption, leading to more efficient and cost-effective secure communication systems.

The quantum transmitter 102, as described in more detail in FIG. 1B, may generate and transmit qubits, which are the quantum bits used to encode information in a quantum state. The quantum transmitter 102 may prepare and transmit qubits over the quantum communication channel 106 to a receiving party (e.g., the quantum receiver 104), enabling secure communication protocols that leverage the principles of quantum mechanics. The quantum transmitter 102 may process qubits by setting them into specific quantum states, such as polarization states of photons or spin states of electrons, depending on the physical implementation of the QKD system. These quantum states may be used to encode information based on quantum superposition and entanglement principles to enable the secure exchange of cryptographic keys.

The quantum communication channel 106 may be a communication medium through which qubits are transmitted from a sender (e.g., quantum transmitter 102) to a receiver (e.g., quantum receiver 104). Unlike classical communication channels (e.g., classical communication channel 108) that transmit bits of information, the quantum communication channel 106 may be configured to preserve and transmit the quantum states of particles, such as photons, over distances without significant loss of information due to decoherence or other quantum noise. The quantum communication channel 106 may be implemented in various mediums based on the application and distance over which communication is required. For example, for terrestrial quantum communication, optical fibers may be used as a medium. The quantum communication channel 106 may use the principles of quantum mechanics, such as the no-cloning theorem and the observation effect (quantum measurements disturb the quantum state), to detect any attempt at eavesdropping during qubit transit. In particular, if an eavesdropper attempts to intercept the qubits, the interception will alter the quantum state of the qubits, allowing the detection of interception by the communicating parties (e.g., quantum transmitter 102, quantum receiver 104).

The classical communication channel 108 may be used for the secure exchange of cryptographic keys alongside the quantum communication channel 106. Unlike the quantum communication channel 106, which transmits qubits to enable the quantum aspects of key distribution, the classical communication channel 108 may be responsible for the transmission of classical bits of information. The classical communication channel may facilitate the exchange of measurement results, measurement basis choices, and other necessary classical data that are not transmitted through the quantum communication channel 106 due to its nature and limitations. QKD systems may use QKD protocols, such as the BB84 protocol, to encode information in qubits using different bases (discussed in more detail in connection with FIG. 1B, below). The communicating parties may use the classical communication channel 108 to disclose the measurement bases used for preparing and measuring each qubit. This coordination may be used to identify specific bits that are used in the final key generation process. In some cases, the classical communication channel 108 may be used to perform error correction, where discrepancies in the shared key are identified and corrected. Following error correction, the classical communication channel 108 may be used to implement privacy amplification to reduce the partial information an eavesdropper might have gained, ensuring the final key is secure. The classical communication channel 108 may be implemented using various technologies, including wired connections like optical fibers or wireless communications such as radio waves. The choice of technology depends on factors such as the required transmission distance, data rates, security requirements, and/or the like.

The quantum receiver 104, as shown and described in more detail in connection with FIG. 1C, may detect and measure the quantum states of incoming qubits transmitted through the quantum communication channel 106. The quantum receiver 104 may reconstruct the quantum information sent by the quantum transmitter 102, enabling the secure exchange of cryptographic keys between the communicating parties. The quantum receiver 104 may measure the quantum states of the incoming bits to allow for subsequent decoding of the information encoded in the quantum states by the quantum transmitter 102. Due to the quantum nature of the communication, the measurement process may be inherently probabilistic, and the choice of measurement basis can affect the outcome. For protocols such as BB84, the quantum receiver 104 may randomly choose between different measurement bases (e.g., rectilinear, diagonal, and/or the like) to measure each incoming qubit. The selection of measurement bases may later be compared with the bases used by the quantum transmitter 102 during the “public discussion” phase over the classical communication channel 108 to sift the qubit measurements that are used to construct the secret key.

A fundamental property of quantum mechanics is that measuring a quantum system inevitably disturbs it. This disturbance can be used to detect the presence of an eavesdropper. If an eavesdropper attempts to intercept and measure the qubits, the quantum states will be altered, introducing errors in the measurements received by the quantum receiver 104. By estimating the error rate in the key exchange process, the quantum receiver 104 may assess the security of the transmission. After the sifting process (e.g., establishing the shared key, as described herein), the quantum receiver 104 may use the classical communication channel 108 to implement error correction to fix discrepancies in the key due to noise or potential eavesdropping, and privacy amplification to shorten the key (and remove bits that might be known to an eavesdropper). In specific embodiments, the quantum receiver 104 may be integrated with a classical communication system (not shown) to facilitate the exchange of information regarding the basis selection, error correction, and privacy amplification. The design and implementation of a quantum receiver 104 may depend on the specific QKD protocol and the type of quantum information carrier (e.g., photons).

The random number generator 110 may be a quantum-based random number generator that generates random numbers by exploiting the inherent unpredictability of quantum mechanical processes. Unlike classical random number generators, which often rely on deterministic processes or algorithms that can produce pseudo-random numbers, quantum-based random number generators may utilize the probabilistic nature of quantum phenomena, such as photon polarization, quantum superposition and entanglement, vacuum fluctuations, atomic decay, and/or the like, to produce true randomness. The random number generator 110 may generate random sequences of bits that form the basis of the cryptographic keys, ensuring the unpredictability of the key. Additionally, the random sequence of bits may dictate the quantum states in which photons are prepared for transmission by the quantum transmitter 102. For example, in the BB84 protocol, the bits may determine both the polarization direction of photons and the basis in which they are encoded. Additionally or alternatively, the random number generator 110 may be a classical true random number generator that generates randomness from physical processes, such as electronic noise or other unpredictable phenomena. True random number generators may provide a higher level of unpredictability and are considered more secure for cryptographic applications. However, classical true random number generators may still be subject to environmental biases and require design and entropy sources to ensure true randomness.

The random number generator 112, similar to the random number generator 110, may be a quantum-based random number generator that generates random numbers by exploiting the inherent unpredictability of quantum mechanical processes. The output from the random number generator 112, in protocols like BB84, may be used by the quantum receiver 104 to select the measurement bases for incoming quantum states, ensuring alignment with the quantum states prepared and transmitted by the quantum transmitter 102. Additionally or alternatively, the random number generator 112, similar to the random number generator 110, may be a classical true random number generator that generates randomness from physical processes, such as electronic noise or other unpredictable phenomena. It is to be understood that any random number generator capable of producing genuine randomness, subject to validation against established standards of randomness quality and security, may be deemed suitable for integration into embodiments described herein. The random number generator 110 may be either integrated directly into the quantum transmitter 102 or operatively coupled therewith. Similarly, the random number generator 112 may be cither integrated directly into the quantum receiver 104 or operatively coupled therewith. The choice between integration and operative coupling may be determined based on factors including, but not limited to, system efficiency, security requirements, scalability, technological compatibility, and/or the like, with the overarching objective of optimizing the performance and reliability of the quantum communication system.

In certain embodiments, the system environment 100 may not include the random number generator 112. Instead, the quantum receiver 104 may employ a strategy of passive measurement basis selection, leveraging the inherent quantum mechanical properties of the photons for basis determination. This approach negates the necessity for an active random number generator (e.g., the random number generator 112) at the quantum receiver 104. The passive basis selection mechanism can be achieved through the use of quantum-optical elements, such as beam splitters or polarization-dependent devices, which intrinsically randomize the measurement basis in accordance with the quantum state's interaction with the device. The passive basis selection mechanism relies on the stochastic nature of quantum mechanics to ensure unpredictability and security in the key distribution process, aligning with the quantum states prepared and transmitted by the quantum transmitter 102.

The structure of system environment 100, as described herein, which facilitates QKD within data center environments, is presented for illustrative purposes only and should not be construed as limiting the scope of the embodiments described and/or claimed in this document. It is emphasized that the specific configuration of the system environment 100, including its constituent components, the interconnections between those components, and the functional dynamics, serves merely as an example instance of how QKD can be implemented within such contexts. Variations in the design and operational framework of the system environment 100 are contemplated. For instance, in one embodiment, the system environment 100 might encompass a greater or smaller number of components, or components differing from those detailed herein. Furthermore, in alternative embodiments, the structural composition of the system environment 100 may undergo modification, whereby portions thereof might be integrated into a unified module, or conversely, the entirety of the system environment 100 may be disaggregated into multiple distinct modules. Such modifications and reconfigurations are envisioned to fall within the purview of the embodiments, underpinning the adaptable nature of system environment 100 in addressing the nuances of QKD deployment within data center landscapes.

### Example Quantum Transmitter Circuitry

FIG. 1B illustrates a schematic block diagram of example circuitry, some or all of which may be included in the quantum transmitter 102. As shown in FIG. 1B, the quantum transmitter 102 may include a quantum light source 116, quantum state preparation circuitry 118, a quantum channel interface 126, and quantum security and protocol management circuitry 128.

As used herein, “circuitry” may refer to all electronic and quantum mechanical components and their respective interconnections, including but not limited to hardware elements, software-driven controls, and any other mechanisms integral to the functionality of the quantum transmitter 102 for QKD. “Circuitry” may also include electronic components such as resistors, capacitors, integrated circuits, and microprocessors; quantum components specifically designed for the generation and manipulation of quantum states; interconnects that facilitate both physical and logical communication between components; control software responsible for operational algorithms and protocols; security and protocol management hardware and software designed to secure cryptographic processes; and interface circuitry for managing connections between the quantum transmitter and the quantum channel. The term “circuitry” is to be interpreted in its broadest sense, inclusive of all elements requisite for the operational efficacy of quantum transmitters, thereby ensuring comprehensive coverage under this definition for the purposes of design, implementation, and functionality within QKD systems.

The light source 116 may be any device capable of emitting light that may be controlled to emit photons one at a time. As described herein, conventional QKD systems operate at 1550 nm, primarily because this wavelength experiences low loss in standard optical fibers, making it ideal for long-distance quantum communication. However, data center environments do not require long-distance quantum communication. The shorter range allows for a shift in the operational wavelength from 1550 nm to 850 nm. The shift facilitates the use of on-chip semiconductor lasers as light sources for operation at 850 nm. Semiconductor lasers, such as vertical-cavity surface-emitting lasers (VCSELs), edge-emitting lasers (EELs), quantum well lasers, quantum cascade lasers (QCLs), distributed feedback lasers (DFBs), external cavity lasers (ECLs), and electro-absorption modulated lasers (EMLs) at 850 nm can be more easily integrated onto semiconductor chips, allowing for the development of more compact and efficient quantum transmitters. This integration may be facilitated by the compatibility of 850 nm semiconductor lasers with existing semiconductor manufacturing processes. Additionally, semiconductor lasers are a cost-effective alternative to other laser types. By shifting to an operational wavelength that allows for the use of semiconductor lasers, the overall cost of quantum communication systems can be significantly reduced, making quantum cryptography more accessible within data center environments. Semiconductor lasers at 850 nm offer desirable performance characteristics, including high modulation speeds, low threshold currents, and the ability to operate at room temperature. These characteristics make them suitable for generating the photons needed for QKD. For QKD applications, it is often necessary to generate single photons on demand. Techniques such as attenuating the semiconductor lasers output or using quantum dot semiconductor lasers can be employed to achieve the requisite single-photon emission characteristics at 850 nm.

The quantum state preparation circuitry 118 may prepare photons in specific quantum states that are used for secure communication between two parties. As shown in FIG. 1B, the quantum state preparation circuitry 118 may include a quantum memory 120 and a quantum processing unit (QPU) 122. Quantum memory 120 may refer to a device or system that is capable of storing quantum information, which may be represented by quantum states, for a period of time. As described herein, the quantum information may be encoded in qubits or qutrits, the fundamental units of quantum information that generalize the classical binary bit to the quantum domain. The quantum memory 120 may be composed of an array of quantum states, each potentially in a superposed configuration. The quantum memory 120 may be responsible for preserving the integrity of quantum states during computation and between operations. In this regard, the quantum memory 120 may employ quantum registers to record the state information of a quantum circuit. In complex quantum systems, the quantum memory 120 can synchronize operations by holding quantum states until they are needed, ensuring that different parts of the system can operate in harmony. For example, in a QKD system where the generation of quantum states and their encoding onto photons might not be perfectly aligned in time, the quantum memory 120 may acts as a buffer that holds quantum states, facilitating a continuous flow of qubits for encoding.

The QPU 122 may refer to a core computational engine that is configured to map the sequence of bits received from the random number generator 110 to specific quantum states and measurement bases. Subsequently, the QPU 122 may control the encoding of these quantum states onto photons, effectively converting classical information into quantum information. For more sophisticated QKD protocols, the QPU 122 may operate using the principles of quantum mechanics to perform the necessary quantum operations on the quantum states prior to their encoding onto photons. These quantum operations may be executed by applying a sequence of quantum gates, which are the building blocks of quantum circuits. These quantum gates may perform unitary operations on qubits, changing their state. In some embodiments, the QPU 122 may generate and manipulate entangled states, a fundamental quantum resource. Entanglement may refer to a phenomenon where qubits become interdependent, such that the state of one qubit instantaneously influences the state of another, regardless of the distance separating them. Due to superposition and entanglement, the QPU 122 can perform many calculations in parallel.

The quantum channel interface 126 may secure transmission of quantum information via the quantum communication channel 106. The quantum channel interface 126 may serve as a bridge between the quantum computing elements within the quantum transmitter 102 and the external quantum communication infrastructure. The quantum channel interface 126 may further encode quantum information—typically in the form of qubits—into a suitable format for transmission through the quantum communication channel 106. This may include the precise manipulation of quantum states to ensure they are compatible with the transmission medium (e.g., optical fibers or free-space channels) and are resilient to errors that might occur during transmission.

The quantum security and protocol management circuitry 128 may be configured to execute secure quantum communications. In this regard, the quantum security and protocol management circuitry 128 may not only manage the protocols necessary for establishing secure quantum communication but also ensure the security of the transmitted quantum information. The quantum security and protocol management circuitry 128 may transmit, through the classical communication channel 108, the measurement basis (or bases) used to encode each bit of the quantum information sent to the quantum receiver 104. As described herein, the measurement basis may be used to interpret the quantum states (qubits) accurately. By transmitting the measurement basis to the quantum receiver 104, the quantum security and protocol management circuitry 128 may ensures that the quantum receiver 104 knows the correct framework (i.e., basis) to use when measuring the received qubits, and subsequently decoding the transmitted information.

Furthermore, the quantum security and protocol management circuitry 128 may receive, also via the classical communication channel 108, a measurement basis from the quantum receiver 104. This received measurement basis is intended for the decoding of each qubit sent from the quantum transmitter 102. The reciprocal exchange of measurement bases via the classical channel 108 allows both parties (e.g., quantum transmitter 102 and quantum receiver 104) to synchronize their understanding and interpretation of the quantum bits exchanged. Specifically, the exchange of measurement bases allows for establishment of a shared encryption key. This key is derived from bits and corresponding qubits that have matching measurement bases, meaning both parties have agreed on the specific bases used for encoding and decoding the qubits. Only qubits measured using the correct measurement basis (and thus correctly interpreted) contribute to the shared encryption key. This method ensures that any eavesdropper lacking access to the information exchanged over the classical channel (specifically, the measurement bases) cannot correctly interpret the quantum states, thereby preserving the security of the communication.

It is to be understood that the structure of the quantum transmitter 102 and its components described herein represents merely one embodiment of a myriad of possible configurations. The structure of the quantum transmitter 102 showcases a specific arrangement and interaction of quantum elements-including qubits, quantum gates, and control mechanisms—that collectively facilitate data transmission for QKD. However, this configuration is not limiting, and the structure of the quantum transmitter 102 and its constituent components can vary to accommodate different quantum computing paradigms, physical implementations, and technological advancements. Alternative embodiments may utilize different types of qubits, such as superconducting circuits, trapped ions, or topological qubits, each with their own unique quantum gate structures and control methodologies. Furthermore, the scalability, error correction techniques, and quantum state readout mechanisms can differ significantly depending on the specific application and operational requirements. Consequently, while the present disclosure provides a comprehensive illustration of one potential quantum transmitter structure, it is to be understood that this is an exemplification of broader principles of quantum computing and should not be construed as a limitation on the scope of the invention, which is capable of being implemented in various other forms, technologies, and configurations.

### Example Quantum Receiver Circuitry

FIG. 1C illustrates a schematic block diagram of example circuitry, some or all of which may be included in the quantum receiver 104. As shown in FIG. IC, the quantum receiver 104 may include a quantum channel interface 130, a photon detector 132, quantum state measurement circuitry 134, and quantum security and protocol management circuitry 142.

As used herein, “circuitry” may refer to all electronic and quantum mechanical components and their respective interconnections, including but not limited to hardware elements, software-driven controls, and any other mechanisms integral to the functionality of the quantum receiver 104 for QKD. “Circuitry” may also include electronic components such as resistors, capacitors, integrated circuits, and microprocessors; quantum components specifically designed for the measurement of quantum states; interconnects that facilitate both physical and logical communication between components; control software responsible for operational algorithms and protocols; security and protocol management hardware and software designed to secure cryptographic processes; and interface circuitry managing connections between the quantum receiver and the quantum channel. The term “circuitry” is to be interpreted in its broadest sense, inclusive of all elements requisite for the operational efficacy of quantum receivers, thereby ensuring comprehensive coverage under this definition for the purposes of design, implementation, and functionality within QKD systems.

The quantum channel interface 130 may serve as an entry point for quantum information arriving from the quantum communication channel 108. The primary function of the quantum channel interface 130 may be to interface with the quantum communication channel 108 to accurately receive quantum signals transmitted by the quantum transmitter 102. These quantum signals may be in the form of photons, the particles of light representing qubits. Upon reception, the quantum channel interface 130 may maintain the integrity of the quantum states for subsequent steps in the QKD process.

The photon detector 132 may be used to detect and subsequently prepare each incoming photon (as received by the quantum channel interface 130) for measurement and analysis. As described herein, to implement QKD in a data center environment, embodiments of the invention shift the operational wavelength of QKD system from the traditional 1550 nm to 850 nm. The shift in operational wavelength from 1550 nm to 850 nm for QKD systems, particularly in a data center environment, allows for the use of silicon-based SPADs as photon detectors due to the inherent properties of silicon and its interaction with different wavelengths of light. Silicon-based SPADs are semiconductor devices fabricated from silicon that are designed to detect and measure single photons with high sensitivity and timing precision. Silicon is most responsive to wavelengths in the visible to near-infrared range (approximately 400 nm to 1100 nm). At 850 nm, which falls within this range, silicon-based SPADs exhibit high quantum efficiency, meaning they are very effective at converting incoming photons Into electrical signals. Furthermore, silicon-based SPADs are less expensive compared to other materials like Indium Gallium Arsenide (InGaAs) used for 1550 nm detection. The lower cost can make the deployment of QKD systems more economically feasible, especially in data center environments where cost efficiency is a priority. Additionally, silicon-based SPADs can offer lower dark count rates (false counts when no photons are present) at 850 nm compared to other photodetector materials at longer wavelengths. Lower noise levels contribute to higher fidelity in photon detection, which helps in maintaining the integrity of the QKD process. Also, data centers often use wavelengths around 850 nm for short-distance optical communications because standard multimode fiber optics are optimized for this wavelength. Using silicon-based SPADs for QKD at 850 nm can leverage existing optical infrastructure, facilitating easier integration and deployment.

The quantum state measurement circuitry 134 may be used to process and interpret the quantum signals detected by the photon detector 132. In this regard, the quantum state measurement circuitry 134 may receive a sequence of bits from a random number generator (e.g., random number generator 112). These bits may be used to determine the measurement basis for each qubit received. As described herein, alternatively, the quantum receiver 104 may implement a passive measurement basis selection to randomize the measurement basis. As shown in FIG. 1C, the quantum state measurement circuitry 134 may include a quantum memory 136, a QPU 138, and quantum error detection and correction circuitry 140. The quantum memory 136, similar to the quantum memory 120, may be a device or system that is capable of recording quantum information, which may be represented by quantum states, for a period of time, ensuring that the quantum information is stored with minimal loss or decoherence.

The QPU 138, similar to the QPU 122, may be a core computational engine configured to execute quantum algorithms to map each bit from the random number generator to a measurement basis and subsequently decode the state of each qubit using the principles of quantum mechanics. In this regard, the QPU 138 may execute computing operations that account for the probabilistic nature of quantum states. Unlike classical bits, which are either 0 or 1, qubits can exist in a superposition of states. The QPU 138 may execute quantum algorithms to collapse the superposition into a definitive state, based on the selected measurement basis. This process translates the quantum information encoded within the qubits into classical information that can be used for cryptographic purposes. When qubits are entangled, the measurement of one qubit instantaneously affects the state of its entangled partner, regardless of the distance separating them. This property is exploited in QKD systems to detect any eavesdropping attempts, as any measurement by an eavesdropper would disturb the entanglement, thereby altering the measurement outcomes. The QPU 138, therefore, may incorporate algorithms that can discern and account for the effects of entanglement on the decoded information, ensuring the integrity and security of the quantum key distribution.

The quantum error detection and correction circuitry 140, given the susceptibility of qubits to errors from environment interference and noise, may be configured to apply quantum error correction codes to identify and rectify any discrepancies in the qubits' states post-measurement. In doing so, the quantum error detection and correction circuitry 140 may ensure that the decoded information accurately reflects the original quantum information, preserving the fidelity of the quantum key distribution.

The quantum security and protocol management circuitry 142, similar to the quantum security and protocol management circuitry 128, may execute secure quantum communications. The quantum security and protocol management circuitry 142 may transmit, via the classical communication channel 108, the measurement basis used to decode each received qubit to the quantum transmitter 102 to enable the quantum transmitter 102 to align its encoding process with the decoding process of the quantum receiver 104. Additionally, and in some embodiments concurrently, the quantum security and protocol management circuitry 142 may receive, via the classical communication channel 108, a measurement basis from the quantum transmitter 102 to decode each qubit transmitted from the quantum transmitter 102 to the quantum receiver 104. The bi-directional exchange of measurement bases via the classical communication channel allows for the synchronization of the encoding and decoding processes between the quantum transmitter 102 and the quantum receiver 104, and the establishment of a shared encryption key between the two parties. The shared encryption key is derived from the bits and their corresponding qubits that have been encoded and decoded using matching measurement bases agreed upon by both parties. Only those qubits that are measured and interpreted correctly using the agreed-upon measurement basis contribute to the formation of the shared encryption key.

It is to be understood that the structure of the quantum receiver 104 and its components described herein represents merely one embodiment of a myriad of possible configurations. The structure of the quantum receiver 104 showcases a specific arrangement and interaction of quantum elements—including qubits, quantum gates, and control mechanisms—that collectively facilitate data transmission for QKD. However, this configuration is not limiting, and the structure of the quantum receiver 104 and its constituent components can vary to accommodate different quantum computing paradigms, physical implementations, and technological advancements. Alternative embodiments may utilize different types of qubits, such as superconducting circuits, trapped ions, or topological qubits, each with its own unique quantum gate structures and control methodologies. Furthermore, the scalability, error correction techniques, and quantum state readout mechanisms can differ significantly depending on the specific application and operational requirements. Consequently, while the present disclosure provides a comprehensive illustration of one potential quantum receiver structure, it is to be understood that this is an exemplification of broader principles of quantum computing and should not be construed as a limitation on the scope of the invention, which is capable of being implemented in various other forms, technologies, and configurations.

### Example Method for Data Transmission in a QKD System Environment

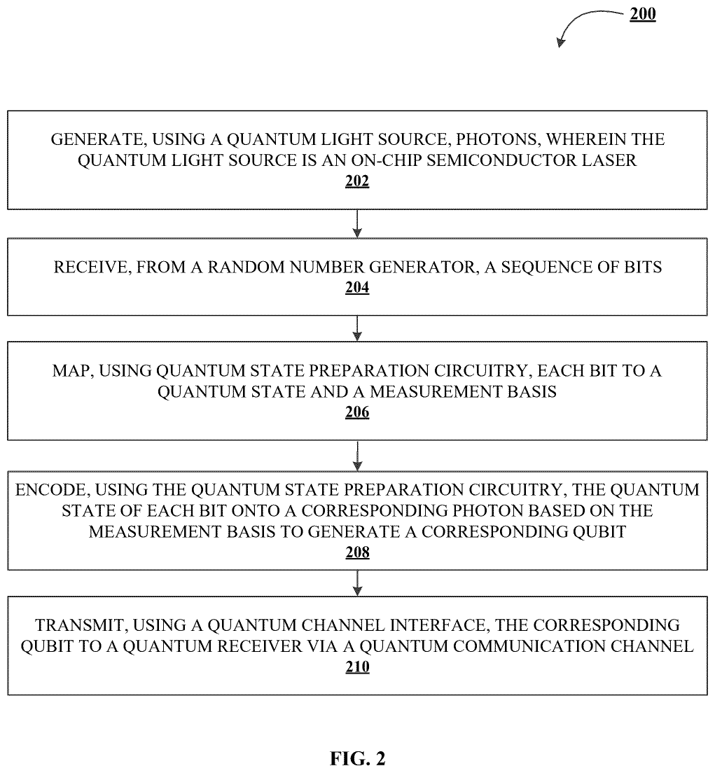

FIG. 2 illustrates an example method 200 for data transmission using a quantum transmitter, in accordance with an embodiment of the invention. As shown in block 202, photons may be generated, using a light source, wherein the light source is an on-chip semiconductor laser. As described herein, a light source may be a device capable of emitting photons one at a time, ensuring that the properties of each photon can be precisely controlled and used for quantum communication. The operational wavelength shift to 850 nm, as discussed herein, facilitates the use of an on-chip semiconductor laser as the light source. In this regard, the on-chip semiconductor laser may be configured as a light source by adjusting the semiconductor laser's emission properties, such as its optical cavity design, to achieve the required emission rate and photon purity necessary for quantum communication. Examples of on-chip semiconductor lasers may include vertical-cavity surface-emitting lasers (VCSELs), edge-emitting lasers (EELs), quantum well lasers, quantum cascade lasers (QCLs), distributed feedback lasers (DFBs), external cavity lasers (ECLs), electro-absorption modulated lasers (EMLs), and/or the like.

The ability to fabricate these semiconductor lasers using standard semiconductor processing techniques not only reduces the cost but also enables the integration of these light sources directly onto chips. This integration facilitates the creation of compact (e.g., having small form factor), scalable, and efficient QKD components suitable for deployment within data center environments. The light source may be configured to emit photons across a broad spectrum, including infra-red, near infra-red, and visible frequencies, allowing for an operational wavelength across the specified spectra. Consequently, the light source may not be limited to a single operational wavelength (e.g., 850 nm) but may instead be capable of functioning effectively across a broader spectrum.

As shown in block 204, according to the method 200, a sequence of bits may be received from a random number generator. As described herein, the random number generator may be a quantum-based random number generator that generates random numbers by exploiting the inherent unpredictability of quantum mechanical processes. Quantum-based random number generators may utilize the fundamentally probabilistic nature of quantum phenomena to produce true randomness. Additionally or alternatively, the random number generator may be a classical true random number generator that generates randomness from physical processes, such as electronic noise or other unpredictable phenomena. True random number generators may provide a higher level of unpredictability and are considered more secure for cryptographic applications.

As shown in block 206, each bit may be mapped, using quantum state preparation circuitry, to a quantum state and a measurement basis. As such, the sequences of bits generated by the random number generator may be mapped to a measurement basis that forms the basis of the cryptographic keys, ensuring the unpredictability of the key. In QKD, the measurement bases may be used to ensure the security and integrity of the communication. Two primary measurement bases used are rectilinear and diagonal, also known as the + and × bases, respectively. The rectilinear basis represents either a horizontally or vertically polarized photon state and can be thought of as 0 degrees and 90 degrees. Similarly, the diagonal basis represents a superposition of the horizontal and vertical states and can be thought of as 45 degrees and 135 degrees. These bases are employed to measure the quantum states of particles, such as photons, which are used as the carriers of information. The choice of measurement basis may be used by protocols such as BB84 to encode and decode the transmitted quantum information securely. Additionally, the sequence of bits may also be mapped to specific quantum states in which photons are to be prepared for transmission by the quantum transmitter. The quantum states may be defined based on the properties of quantum particles, such as photons, and their attributes, such as polarization or phase, to represent their values. For example, in a polarization-based system, a 0 might be mapped to a horizontally polarized photon, and a 1 might be mapped to a vertically polarized photon. Other systems such as phase-based encoding and frequency-based encoding may also be used to characterize the quantum states. As such, the quantum state may be described by a vector in a two-dimensional Hilbert space, characterized by two basis states, often denoted as |0z,21 and |1 [symbol] .

As shown in block 208, the quantum state of each bit may be encoded, using the quantum state preparation circuitry, onto a corresponding photon based on the measurement basis to generate a corresponding qubit. As described herein, encoding the quantum state of each bit of a corresponding photon may include utilizing quantum properties of photons to represent binary information—0s and 1s. Encoding may be achieved through the polarization states of photons or other quantum properties such as the phase, spin, or time-bin encoding, depending on the specific protocol used. Each of these properties can be set to represent binary information using the principles of quantum mechanics according to the measurement basis to generate corresponding qubits. For example, in a polarization-based system, the encoding process may begin with the preparation of a photon in a specific polarization state. This may be achieved using various optical devices, such as polarizers, which filter photons into a desired polarization state, and phase shifters, which can adjust the phase between different components of a superposition state, allowing for the creation of arbitrary qubit states. To encode a qubit in a superposition or a specific quantum state, the quantum state preparation circuitry may employ optical elements such as phase shifters, wave plates, and/or the like, to change the relative phase or rotate the polarization of the photon, enabling the encoding of quantum information in the polarization state of the photon.

As shown in block 210, the corresponding qubit may be transmitted, using a quantum channel interface, to a quantum receiver via a quantum communication channel. As described herein, the quantum communication channel may be the conduit through which the qubit is transmitted from the quantum transmitter to a quantum receiver.

In addition to transmitting the qubits via the quantum communication channel, the method may transmit, using quantum security and protocol management circuitry, the measurement basis (or bases) used to encode each bit of quantum information to the quantum receiver via a classical communication channel. Additionally, and in some embodiments concurrently, the method may receive, also via the classical communication channel, a measurement basis (or bases) from the quantum receiver. The reciprocal exchange of measurement bases via the classical channel allows both the quantum transmitter and the quantum receiver to establish a shared encryption key. This key is derived from bits and corresponding qubits that have matching measurement bases, meaning both parties have agreed on the specific bases used for encoding and decoding the qubits. Only qubits measured using the correct measurement basis (and thus correctly interpreted) contribute to the shared encryption key.

### Example Method for Data Reception in a OKD System Environment

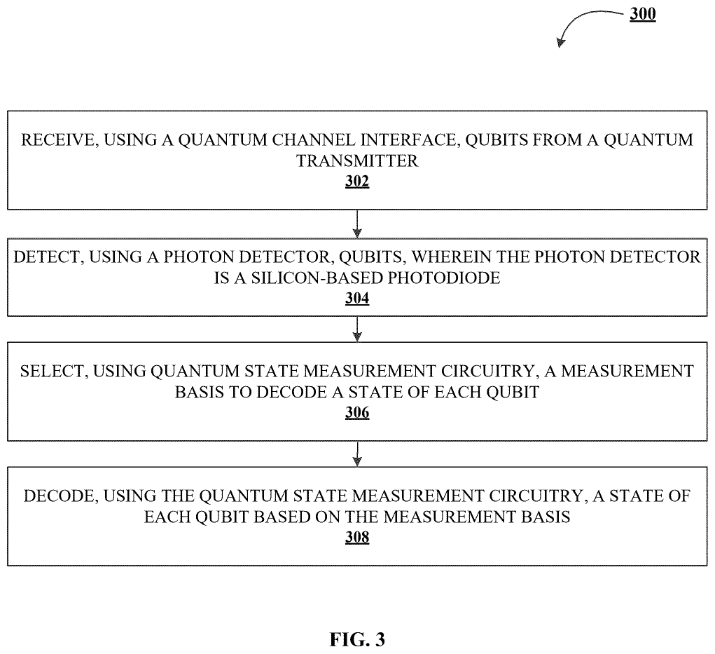

FIG. 3 illustrates an example method 300 for data reception using a quantum transmitter, in accordance with an embodiment of the invention. As shown in block 302, qubits may be received, using a quantum channel interface, from a quantum transmitter.

As shown in block 304, the qubits may be detected, using a photon detector, wherein the photon detector is a silicon-based single photon avalanche diode (SPAD). In QKD, the detection of qubits may be achieved using photon detectors. As described herein, the shift toward an operational wavelength of 850 nm facilitates the use of silicon-based SPADs for qubit detection as SPADs exhibit efficient photoelectric conversion and sensitivity in the visible to near-infrared spectrum, up to approximately 1100 nm. The 850 nm wavelength falls within this responsive range of silicon, thereby enabling effective photon detection using silicon-based SPADs.

Silicon-based SPADs offer high quantum efficiency and low noise levels at 850 nm, enhancing the accuracy of qubit detection. Furthermore, the use of silicon-based technology can lead to cost reductions, given the widespread availability and the mature manufacturing ecosystem for silicon semiconductors. Also, the shift to a shorter wavelength, while still within the low-loss window of optical fibers, allows for integration with components that are both compact and compatible with existing optical communication technologies, potentially broadening the applicability and accessibility of QKD systems. Additionally, employing silicon-based technology allows the quantum receiver to have a small form factor construction (e.g., less than 40 cm³ in volume).

As shown in block 306, according to the method 300, a measurement basis may be selected, using quantum state measurement circuitry, to decode a state of each qubit. In this regard, in some embodiments, a sequence of bits may be received from a random number generator. As described herein, the random number generator may be used in cryptographic processes, including QKD, for creating secure keys that are unpredictable and, therefore, secure. The sequence of bits generated by the random number generator may be subsequently used in the mapping process, where each bit is associated with a specific measurement basis (e.g., rectilinear, diagonal, and/or the like). Upon receiving the sequence of bits, each bit may be mapped, using a quantum state measurement circuitry, to a measurement basis. As described herein, the measurement basis may relate to the orientation or the framework within which a quantum system's state is measured. The mapping process may involve associating each bit from the random sequence to a specific quantum measurement basis, which will be used to interpret the state of the received qubits.

In some other embodiments, passive measurement basis selection may be employed, leveraging the inherent quantum mechanical properties of the photons for basis determination. In this regard, quantum-optical elements, such as beam splitters or polarization-dependent devices, may be used to intrinsically randomize the measurement basis used by the quantum receiver to decode the state of each qubit. The passive basis selection mechanism relies on the stochastic nature of quantum mechanics to ensure unpredictability and security in the key distribution process, aligning with the quantum states prepared and transmitted by the quantum transmitter.

As shown in block 308, a state of each qubit may be decoded, using the quantum state measurement circuitry, based on the measurement basis. Decoding, as described herein, may include determining the qubit's state (e.g., 0 or 1) by performing a measurement in the specified basis to extract the information encoded in the qubit. Furthermore, the decoding process may include comparing the decoded qubit states against the expected states, as predetermined by the QKD protocol. Discrepancies between the measured and expected states can indicate potential eavesdropping or errors in the quantum communication channel. In addition, the decoding process may include the application of error correction techniques to rectify any discrepancies detected during the comparison phase.

In addition to detecting and measuring qubits, according to the method 300, the measurement basis (or bases) used to encode each quantum bit may be received, via a classical communication channel, from the quantum transmitter. Additionally, the quantum receiver may, in some embodiments concurrently, transmit, also through the classical communication channel, its own measurement basis (or bases) to the quantum transmitter. This reciprocal exchange of measurement bases via the classical communication channel facilitates the establishment of a mutual encryption key between the quantum transmitter and the quantum receiver. This encryption key may be generated from matching bits and corresponding qubits with aligned measurement bases, signifying consensus on the specific bases employed for encoding and decoding the qubits. Solely qubits measured utilizing the accurate measurement basis (and thereby correctly deciphered) may contribute to the formation of the shared encryption key.

Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases the method may include additional steps. The steps and modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A quantum transmitter for use in quantum key distribution (QKD), the quantum transmitter comprising:
a light source configured to generate photons, wherein the light source is an on-chip semiconductor laser;
quantum state preparation circuitry operatively coupled to the light source and configured to:
receive a sequence of bits;
map each bit to a quantum state and a measurement basis; and
encode the quantum state of each bit onto a corresponding photon based on the measurement basis to generate a corresponding qubit; and
a quantum channel interface operatively coupled to the quantum state preparation circuitry and configured to transmit the corresponding qubit to a quantum receiver via a quantum communication channel.

2. The quantum transmitter of claim 1, wherein the light source is further configured to generate the photons at an infra-red frequency, a near infra-red frequency, or a visible spectrum frequency.

3. The quantum transmitter of claim 1, wherein the light source is further configured to generate the photons at an operational wavelength of around 850 nm.

4. The quantum transmitter of claim 1, wherein the quantum transmitter has a small form factor that is less than 40 cm³ in volume.

5. The quantum transmitter of claim 1, wherein the quantum transmitter is configured to operate at a room temperature.

6. The quantum transmitter of claim 1, further comprising security and protocol management circuitry configured to:
transmit, via a classical communication channel, the measurement basis used to encode each bit to the quantum receiver.

7. The quantum transmitter of claim 6, wherein the security and protocol management circuitry is further configured to:
receive, from the quantum receiver via the classical communication channel, a measurement basis for decoding each qubit; and
establish a shared encryption key with the quantum receiver using bits and corresponding qubits having matching measurement bases.

8. The quantum transmitter of claim 1, wherein a transmission distance between the quantum transmitter and the quantum receiver is less than 2 km.

9. The quantum transmitter of claim 1, wherein the quantum state preparation circuitry is configured to receive the sequence of bits from a random number generator.

10. A quantum receiver for use in quantum key distribution (QKD), the quantum receiver comprising:
a quantum channel interface configured to receive, via a quantum communication channel, qubits from a quantum transmitter;
a photon detector operatively coupled to the quantum channel interface and configured to detect the qubits, wherein the photon detector is a silicon-based single photon avalanche diode (SPAD); and
quantum state measurement circuitry operatively coupled to the photon detector and configured to:
select a measurement basis to decode a state of each qubit; and
decode the state of each qubit based on the measurement basis.

11. The quantum receiver of claim 10, wherein the photon detector is further configured to detect the qubits at an infra-red frequency, a near infra-red frequency, or a visible spectrum frequency.

12. The quantum receiver of claim 10, wherein the photon detector is further configured to detect the qubits at an operational wavelength of around 850 nm.

13. The quantum receiver of claim 10, wherein the quantum receiver has a small form factor that is less than 40 cm³ in volume.

14. The quantum receiver of claim 10, wherein the quantum receiver is configured to operate at a room temperature.

15. The quantum receiver of claim 10, further comprising security and protocol management circuitry configured to:
transmit, via a classical communication channel, the measurement basis used to decode each qubit to the quantum transmitter.

16. The quantum receiver of claim 15, wherein the security and protocol management circuitry is further configured to:
receive, from the quantum transmitter via the classical communication channel, a measurement basis used to encode each bit; and
establish a shared encryption key with the quantum transmitter using bits and corresponding qubits with matching measurement bases.

17. A method for data transmission using quantum transmitter in quantum key distribution (QKD), the method comprising:
generating, using a light source, photons, wherein the light source is an on-chip semiconductor laser;
receiving a sequence of bits;
mapping, using a quantum state preparation circuitry, each bit to a quantum state and a measurement basis;
encoding, using the quantum state preparation circuitry, the quantum state of each bit onto a corresponding photon based on the measurement basis to generate a corresponding qubit; and
transmitting, using a quantum channel interface, the corresponding qubit to a quantum receiver via a quantum communication channel.

18. The method of claim 17, wherein the photons are generated at an operational wavelength of around 850 nm.

19. A method for data reception using quantum receiver in quantum key distribution (QKD), the method comprising:
receiving, using a quantum channel interface, qubits from a quantum transmitter;
detecting, using a photon detector, qubits, wherein the photon detector is a silicon-based single photon avalanche diode (SPAD);
selecting, using a quantum state measurement circuitry, a measurement basis to decode a state of each qubit; and
decoding, using the quantum state measurement circuitry, a state of each qubit based on the measurement basis.

20. The method of claim 19, wherein the qubits are detected at an operational wavelength of around 850 nm.

21. A quantum transmitter for use in quantum key distribution (QKD), the quantum transmitter comprising:
a light source configured to generate photons, wherein the light source is configured to generate the photons at an operational wavelength of around 850 nm;
quantum state preparation circuitry operatively coupled to the light source and configured to:
receive a sequence of bits;
map each bit to a quantum state and a measurement basis; and
encode the quantum state of each bit onto a corresponding photon based on the measurement basis to generate a corresponding qubit; and
a quantum channel interface operatively coupled to the quantum state preparation circuitry and configured to transmit the corresponding qubit to a quantum receiver via a quantum communication channel.

22. The quantum transmitter of claim 21, wherein the light source is an on-chip semiconductor laser.

23. A quantum receiver for use in quantum key distribution (QKD), the quantum receiver comprising:
a quantum channel interface configured to receive, via a quantum communication channel, qubits from a quantum transmitter;
a photon detector operatively coupled to the quantum channel interface and configured to detect the qubits, wherein the photon detector is configured to detect the qubits at an operational wavelength of around 850 nm; and
quantum state measurement circuitry operatively coupled to the photon detector and configured to:
select a measurement basis to decode a state of each qubit; and
decode the state of each qubit based on the measurement basis.

24. The quantum receiver of claim 23, wherein the photon detector is a silicon-based single photon avalanche diode (SPAD).
